(19) United States
(12) Patent Application Publication
(10) Pub. No.: US 2010/0015386 A1
(43) Pub. Date: Jan. 21, 2010

(54) COMPOSITE ELEMENT FOR A HOOK-AND-LOOP FASTENER

(76) Inventors: Georg Baldauf, Laer (DE); Dieter Homoelle, Ochtrup (DE)

Correspondence Address: K.F. ROSS P.C., 5683 RIVERDALE AVENUE, SUITE 203 BOX 900, BRONX, NY, 10471-0900, US

(21) Appl. No.: 12/503,910

(22) Filed: Jul. 16, 2009

(30) Foreign Application Priority Data
Jul. 17, 2008 (EP) 08012900.0

(51) Int. Cl. B32B 3/06

(52) U.S. Cl. 428/99

(57) ABSTRACT

A loop-side composite element of a hook-and-loop fastener has an air-permeable textile substrate having an outer edge and a face and an air-permeable and loop-forming functional textile layer generally congruent to and overlying the face of the substrate. An annular adhesive strip extends along the outer edge, is bonded to the face of the functional layer and a confronting face of the substrate, and defines on the face of the substrate an open center region. A plurality of adhesive spots spaced apart on the face of the substrate in the open region are each bonded to the face of the substrate and to the confronting face of the functional layer. The faces are free of adhesive and not bonded to each other in the region between the spots. The gluing or laminating may be accomplished using a reactive PUR adhesive or a hot-melt adhesive.

### FIELD OF THE INVENTION

The present invention relates to a hook-and-loop fastener. More particularly this invention concerns a composite element or tape forming the loop side of the fastener.

### BACKGROUND OF THE INVENTION

A standard tape, such as used in a disposable diaper, for the loop side of a hook-and loop (Velcro™) fastener is typically formed of a textile substrate to which is laminated a loop-forming functional layer into which the hooks of the other side of the fastener can engage.

Such hook-and-loop fasteners basically consist of a (male) fastening component having an array of flexible hooks and a (female) component forming an array of loops releasably engageable with the hooks. Fasteners of this nature can be produced cost effectively, can be operated easily, and can be opened and closed repeatedly without degrading. Hence, diapers, among other things, are equipped with such hook-and-loop fasteners. Compared to alternatively utilized adhesive fasteners, hook-and-loop fasteners used with diapers offer the advantage that they can still be closed even when they get into contact with, for example, baby oil or skin lotion, and they hold even when wet.

A composite element comprising the female fastening portion particularly of a diaper hook-and-loop fastener is disclosed, for example, in U.S. Pat. No. 7,527,848. It comprises a textile functional layer is applied to a substrate film, the textile functional layer comprising loops on its surface to anchor the hook-and-loop hooks. Such composite elements are usually mounted at the side ends of the diaper, so that the diaper can be closed with suitable closure tapes, with the latter comprising the necessary hook-and-loop hooks. The composite elements described there have a pleasantly soft and thus hypoallergenic surface feel. As a result of the substrate film, however, the closure component of the hook-and-loop fastener is not air-permeable.

### OBJECTS OF THE INVENTION

It is therefore an object of the present invention to provide an improved loop-side composite element for a hook-and-loop fastener.

Another object is the provision of such an improved loop-side composite element for a hook-and-loop fastener that overcomes the above-given disadvantages, in particular whose breathability is improved without negatively impacting the look, feel, or function.

### SUMMARY OF THE INVENTION

A loop-side composite element of a hook-and-loop fastener has according to the invention an air-permeable textile substrate having an outer edge and a face and an air-permeable and loop-forming functional textile layer generally congruent to and overlying the face of the substrate. An annular adhesive strip extends along the outer edge, is bonded to the face of the functional layer and a confronting face of the substrate, and defines on the face of the substrate an open center region. A plurality of adhesive spots spaced apart on the face of the substrate in the open region are each bonded to the face of the substrate and to the confronting face of the functional layer. The faces are free of adhesive and not bonded to each other in the region between the spots. The gluing or laminating may be accomplished using a reactive PUR adhesive or a hot-melt adhesive.

The combination of two wholly textile and thus air-permeable layers, in each case, glued to each other in such a way that the composite material comprises adhesive-free areas is also air-permeable overall. This makes the laminate composite material breathable and especially suitable for use as a female closure element of a diaper. The anchoring of the hook-and-loop hooks of a (male) closure tape is favored by gluing part of the surface of the functional layer to the textile substrate insofar as the hook-and-loop hooks can deeply engage with the functional layer. Gluing the entire periphery of the composite element according to the invention prevents the outer surfaces of the textile from ripping or tearing when opening the closure. This makes the closure very durable, so that the closure can be used many times. Moreover, the hook-and-loop hooks of the closure tape will engage less intensely with the peripheral areas of the composite element, thus reducing the material's exposure to wear when opening the closure. This, too, helps in preventing the composite element according to the invention from fraying, even if used frequently, and also helps it maintain its functionality at its outer edge.

The composite element according to the invention may have a textile substrate comprised of a spunbond that preferably has a basis weight of 10 to 50 g/m². This causes the composite element to be quite light. For diaper products this characteristic is important insofar as they must be acquired and disposed of in great quantities in most cases. The lowest possible weight represents an important advantage in this connection. The spunbond may be opaque, white or multi-colored.

The textile substrate may comprised of polyolefins (for example PP or PE), polyolefin copolymers, polyamides (PA) or polyester (for example PET) fibers. Such textiles have for the user of the closure a soft and hypoallergenic feel. Hence, in conjunction with the air permeability of the composite element according to the invention, the diaper closure components are rarely felt as uncomfortable when in contact with skin.

Pursuant to a preferred version of the composite element according to the invention, the textile functional layer is a warp knit, with textile chain links and loops formed by means of a method and are suited in a special manner for the engagement of the hook-and-loop hooks. Thus, when closing the closure it is possible for the greatest possible number of hooks to engage loops, making the closure hold more solidly. Alternatively to the warp-knitted good, the functional layer may also be comprised of a woven or nonwoven textile, which makes the whole laminate composite material feel fluffy and less scratchy on the skin. The nonwoven fabric may for example be comprised of PA, PET or PP. A diaper with fluffy components is generally considered the most comfortable kind to wear.

Within the adhesive frame the adhesive spots form particularly a strip-shaped, lattice-shaped, point-shaped or cell-shaped structure, and the portion of area within the frame covered by adhesive amounts to 10 to 70%, preferably 40 to 60%. The formation of unglued textile areas enhances the air permeability of the laminate composite material and, simultaneously, has a favorable effect on the closure properties. The reason for the latter is that the hook-and-loop hooks of a closure tape in a unglued textile area of the functional layer encounter loops or the like not only at the upper surface of the layer, but also within the layer, and on its unglued lower surface by engaging completely through the functional layer. In this connection, the ratio of the glued area as part of the composite element's entire area, and also the form or the type of adhesion, depends on the selection of the material and the acting opening forces. If the ratio of the glued area is larger than 70%, a spunbonded-melt-blown-spunbonded composite (SMS) made of propylene having a basis weight of 10 to 20 g/m² may be used.

### BRIEF DESCRIPTION OF THE DRAWING

The above and other objects, features, and advantages will become more readily apparent from the following description, reference being made to the accompanying drawing in which:

FIG. 1 is a large-scale vertical section through a composite element according to the invention;

FIG. 2 is a top view of the substrate layer of the composite element; and

FIG. 3 is a view like FIG. 2 of another substrate according to the invention.

### SPECIFIC DESCRIPTION

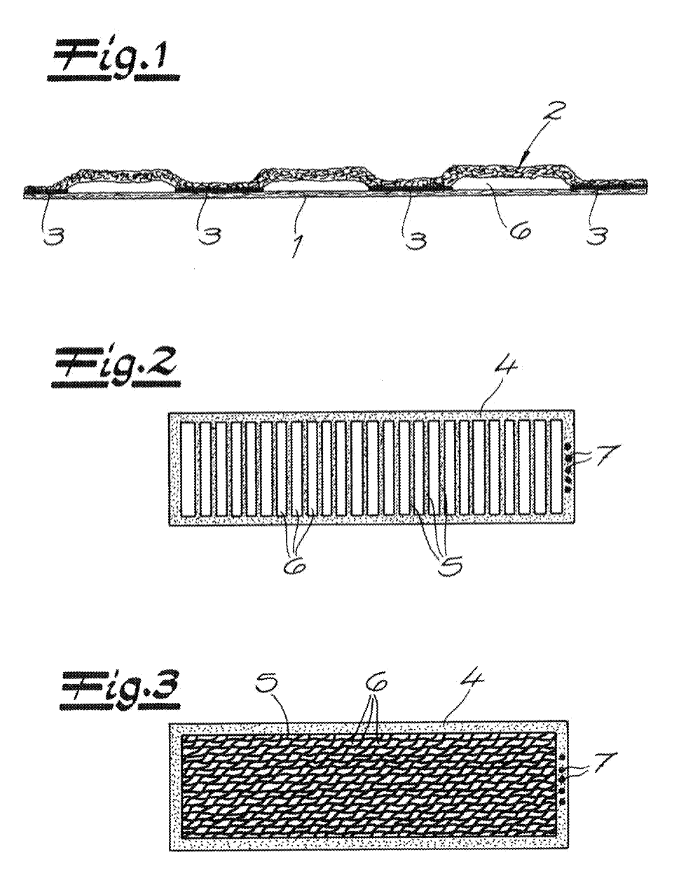

As seen in FIG. 1 a composite element for a hook-and-loop fastener, in particular for a diaper fastener is comprised of a textile substrate 1 and a loop-forming textile functional layer 2 laminated on the substrate 1 for the engagement of unillustrated hook-and-loop hooks. The textile substrate 1 and the textile functional layer 2 are glued to each other and are both air-permeable. The adhesive 3 is applied to the substrate 1 in a pattern that features an annular strip or frame 4 with adhesive applied to the rectangular region defined inside the frame as a plurality of air-impermeable spots 5 separated by adhesive-free areas or regions 6. The adhesive frame 4 extends along the outer edge of the composite element.

The textile substrate 1 may for example be comprised of a spunbond that preferably has a basis weight of 10 to 50 g/m². It may be comprised of polyolefins, polyolefin copolymers, polyamides or polyester fibers. The textile functional layer 2 may for example be comprised of a warp, a woven textile, or a nonwoven textile. The unglued areas 6 of the functional layer 2 may interact with hook-and-loop hooks of a closure tape, on the top as well as on the bottom. This effect is enhanced as a result of the flexibility of the functional layer 2 in these areas 6, since, for example, hook-and-loop hooks can engage through yarns from the center of the functional layer. Excessive ripping or fraying of the functional layer 2 is prevented in that the functional layer 2 is firmly glued to the textile substrate 1 at regular intervals over the entire area of the laminated composite material.

FIG. 2 shows a top view of an illustrated embodiment of the substrate 1 and adhesive 4, 5. The strip pattern is selected such that the adhesive spots 5 are formed as strips. The adhesive-free areas 6 also are strips interleaved with the adhesive strips 5 and extending perpendicular to the long dimension (right to left in FIG. 2) of the element. The adhesive frame 4 prevents ripping or fraying of the textile when opening the hook-and-loop fastener. The adhesive surfaces 5 cover 10 to 70% of the area or region defined within the adhesive frame 4. The portion of the region covered by the glued surfaces 5 depends on the forces transmitted by the hook-and-loop tape to the laminated composite material when opening the fastener. Frequently, an adhesive coverage of 40 to 60% is advantageous.

A composite element comprising smaller adhesive-free areas 6, namely with a larger portion of the glued surfaces, is shown in FIG. 3. The strip pattern is arranged such that a lattice structure results having thin longitudinally extending lines or strips and thin transversely extending strips at a nonright angle to form small parallogrammatic adhesive-free areas 6. Alternatively to the strips or to the lattice, other patterns can also be provided so that, for example, a point-shaped, cell-shaped or wave-shaped structure results. With respect to the manufacture and subsequent processing of the composite element, the composite element can be imprinted with a marking or indicia 7 that control cutting to length or mounting of the element. Such a marking 7 can be imprinted with a visible dye, or alternatively with a dye that only becomes visible after being illuminated with, for instance, ultraviolet light.

We claim:

1. A loop-side composite element of a hook-and-loop fastener, the element comprising:
an air-permeable textile substrate having an outer edge and a face;
an air-permeable and loop-forming functional textile layer generally congruent to and overlying the face of the substrate;
an annular adhesive strip extending along the outer edge, bonded to the face of the functional layer and a confronting face of the substrate, and defining on the face of the substrate an open center region; and
a plurality of adhesive spots spaced apart on the face of the substrate in the open region and each bonded to the face of the substrate and to the confronting face of the functional layer, the faces being free of adhesive and not bonded to each other in the region between the spots.

2. The loop-side composite element defined in claim 1 wherein the substrate is a spunbond.

3. The loop-side composite element defined in claim 2 wherein the spunbond has a mass per unit area of 10 g/m² to 50 g/m².

4. The loop-side composite element defined in claim 1 wherein the textile substrate is comprised of polyolefin copolymers, polyamides or polyester fibers.

5. The loop-side composite element defined in claim 1 wherein the functional layer is comprised of a warp-knit, a weave, or a nonwoven.

6. The loop-side composite element defined in claim 1 wherein the spots are parallel spaced strips.

7. The loop-side composite element defined in claim 1 wherein the strips form a lattice in the region.

8. The loop-side composite element defined in claim 1 wherein the outer edge and annular adhesive strip are generally rectangular and the spots are parallel spaced strips in the region.

9. The loop-side composite element defined in claim 1 wherein the spots cover between 10% and 70% of the region.

10. The loop-side composite element defined in claim 1 wherein the spots cover between 40% and 60% of the region.

11. The loop-side composite element defined in claim 1 wherein the spots are uniformly distributed in the region.

12. The loop-side composite element defined in claim 1 wherein the substrate and functional layer are rectangular, elongated, and congruent, the strip being rectangular, the spots being transverse parallel strips.
